(19) United States
(12) Patent Application Publication
(10) Pub. No.: US 2009/0021328 A1
(43) Pub. Date: Jan. 22, 2009

(54) MICROWAVE UNIT

(76) Inventors: Adrian Haldimann, Jegenstorf (CH); Patrick Linder, Mandach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/815,773

(22) PCT Filed: Feb. 7, 2006
(86) PCT No.: PCT/CH2006/000081

§ 371 Date: Sep. 10, 2008

(30) Foreign Application Priority Data
Feb. 9, 2005 (CH) PCT/CH2005/000071

(51) Int. Cl. H01P 7/06

(52) U.S. Cl. 333/227

(57) ABSTRACT

A device with a cavity resonator comprises a housing (3, 4, 12) made of electrically conductive material. A reflector unit (11), a microwave unit (9) and a partially reflecting reflector unit (5) are provided inside the housing (3, 4, 12), the housing (4) having a radiation opening (13). The reflector unit (11), the microwave unit (9), the partially reflecting reflector unit (5) and the radiation opening (13) are situated on a radiation axis (14), the microwave unit (9) being placed between the reflector units (5, 11). In addition, a distance between the reflector unit (11) and the partially reflecting reflector unit (5) corresponds to half a wavelength to be generated or to be detected or to several times this half wavelength. At the same time, a measurement transversal to the radiation axis (14) is at least one fourth of the wavelength.

The present invention relates to a device with a cavity resonator for generating and detecting, respectively, microwaves.

Microwave units for the generation of microwave beams are known since the 1950ies, wherein the generated microwave beams have been referred to by the acronym MASER, which stands for Microwave Amplification by Stimulated Emission of Radiation. At that time, C. H. Towns developed the first MASERs and filed therefor a patent application which lead to the U.S. patents with the publication Nos. U.S. Pat. No. 2,929,922 and U.S. Pat. No. 2,879,439.

Furthermore, it is referred to DE-1 566 036, in which a high-frequency MASER is described, too.

The known microwave units are all characterized by a relatively large size and a relatively low efficiency.

The present invention is therefore based on the problem to show a device for generating and detecting, respectively, microwaves which does not have the before-mentioned disadvantages.

This problem is solved by the provisions designated in the characterizing portion of patent claim 1. Advantageous embodiments of the invention are given in further claims.

By providing in the housing a reflector unit, a microwave unit and a partially reflecting reflector unit, the housing having a radiation opening, the reflector unit, the microwave unit, the partially reflecting reflector unit and the radiation opening lying on a radiation axis, wherein the microwave unit is arranged between the reflector units, a distance between the reflector unit and the partially reflecting reflector unit corresponding to half a wavelength to be generated and to be detected, respectively, or to several times this half wavelength, and a dimension transversal to the radiation axis being at least a quarter of the wavelength, a device for generating and detecting, respectively, of microwaves is provided which in particular has the following advantages:
The efficiency, which is calculated from the radiated microwave energy and the spent energy, is clearly improved with respect to conventional devices which base on a cavity resonator.
The effort for generating microwave beams of high energy density is low.
When used in a directional transmission connection, the microwave beam generated with the invention has a clearly lower distance loss compared to conventional directional transmission connections.
The frequency of the cavity resonator can be changed mechanically as well as electrically within a certain range, for example from 9 to 12 GHz, as well as be tuned to fixed frequencies in this range.

In the following, the invention is more closely described by means of drawings which show different embodiments for illustrating the invention. Therein show:

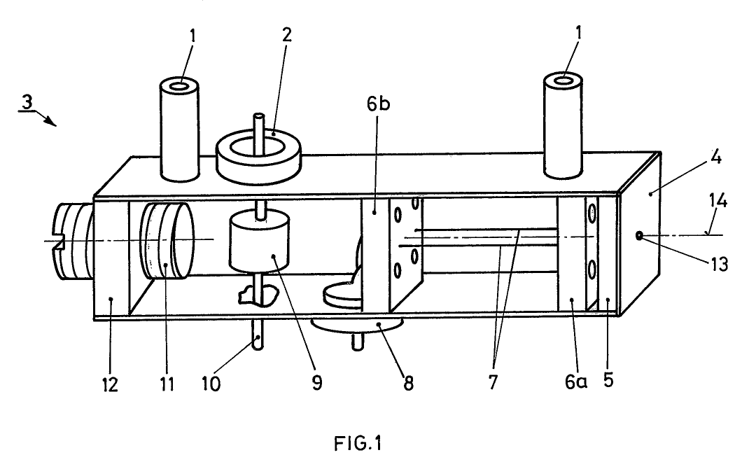

FIG. 1 an embodiment of a device according to the invention in perspective view and with removed sidewall,

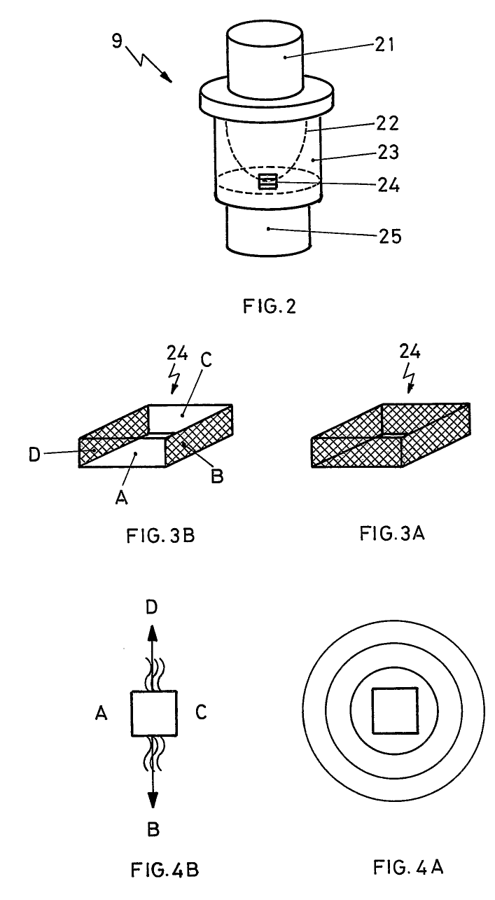

FIG. 2 a Gunn-diode as it is applied in the device according to the invention according to FIG. 1,

FIGS. 3A and 3B a known and a special design of the electronic component (Chip) of the Gunn-diode according to FIG. 2,

FIGS. 4A and 4B the radiation characteristic of the known and of the special design of the electronic component according to FIGS. 3A and 3B,

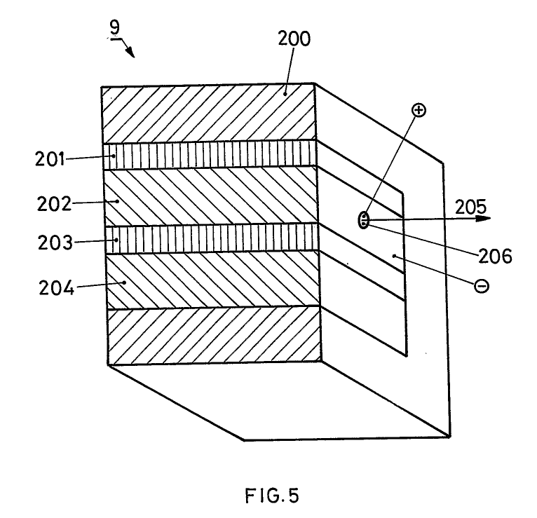

FIG. 5 in schematic representation, a portion of a microwave unit in a section parallel to a longitudinal axis,

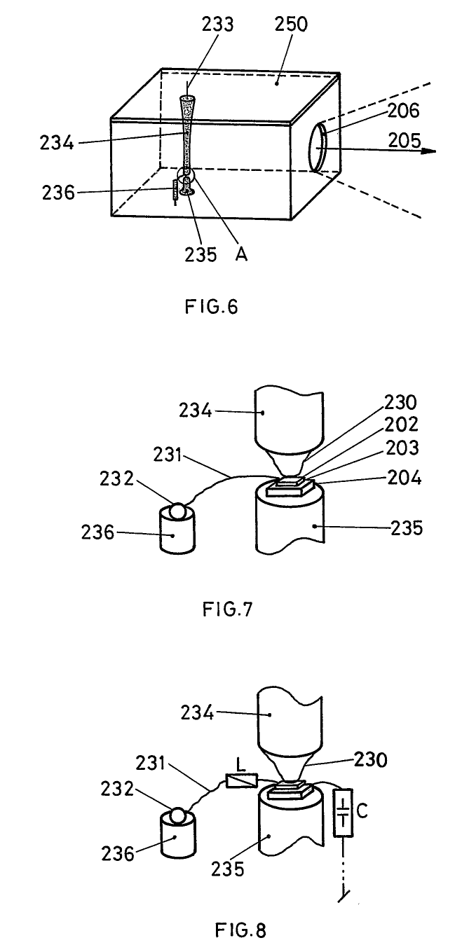

FIG. 6 a cavity resonator with another embodiment of a portion of a microwave unit,

FIG. 7 a detailed view of the other embodiment for the portion of the microwave unit according to FIG. 6,

FIG. 8 a detailed view according to FIG. 7 of a third embodiment for a portion of the microwave unit,

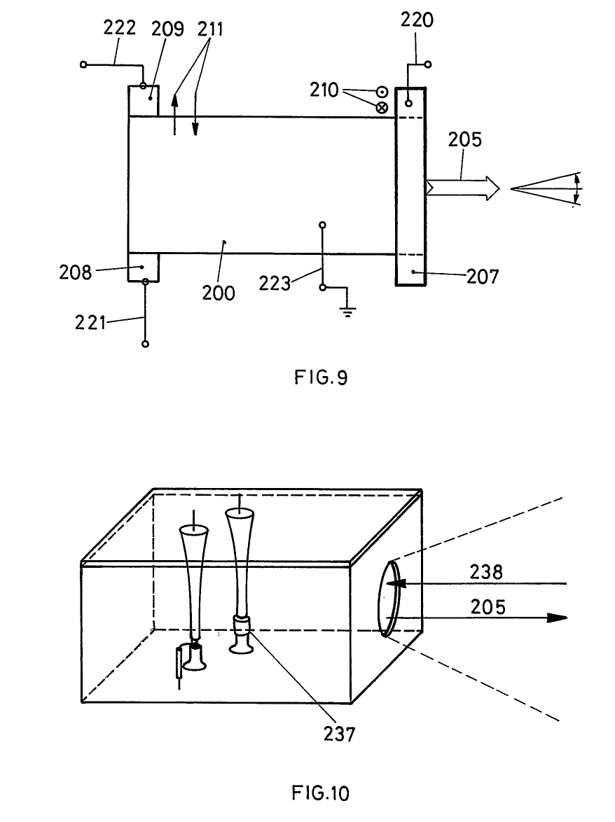

FIG. 9 the microwave unit according to FIG. 5 with a device for aligning the microwave beam, and

FIG. 10 an embodiment with a separate receiving diode.

FIG. 1 shows a device according to the invention for the generation and detection, respectively, of microwaves in a perspective view, wherein one sidewall of a housing 3 is transparent, so that the view for the viewer into the inside of the housing 3 is given free. The housing 3 forms a rectangularly shaped cavity resonator the longitudinal axis of which coincides with a radiation axis 14. On this radiation axis 14, a reflector unit 11, a microwave unit 9, a partially reflecting reflector unit 5 and a radiation opening 13 leading through the housing 3 are arranged. The housing forming the cavity resonator consists of a microwave-reflecting material, preferably a metal such as tinplate, the thickness of which is at least 0.3 mm, preferably larger than 0.5 mm. The microwave unit 9 is arranged between the reflector unit 11 and the partially reflecting reflector unit 5, wherein the frontplate 4 with the radiation opening 13 closes the cavity resonator on the side of the partially reflecting reflector unit 5.

In order to be able to obtain a maximum power by means of the device according to the invention, the distance between the reflector unit 11 and the partially reflecting reflector unit 5 has to be adjusted equal to the wavelength to be generated and to be detected, respectively, or to several times this wavelength. The dimension transversal to the radiation axis 14 furthermore corresponds to at least a quarter of this wavelength. Accordingly, in particular also the operation of the device according to the invention with the dimension corresponding to a half the wavelength is thinkable.

FIG. 1 shows a rectangularly-shaped cavity resonator. Of course, a cylinder-shaped cavity resonator is suitable in the same way.

In a first embodiment of the device according to the invention, a so-called Gunn-diode is used as microwave unit 9. For example, a standard Gunn-diode with the reference MG1005-11 of the company MDT can be used. This Gunn-diode generates a microwave signal with a frequency of 9.35 GHz at a power of 50 mW and consists of a gold-plated anode, a gold-plated cathode, a ceramics hollow body, a bonding wire as well as a chip preferably based on GaAs with an area of about 0.36 mm² at a height of 0.04 mm. Whereas the cathode 10 of the Gunn-diode is lead to the outside for contacting, the anode is lead to the outside via a feedthrough capacitor 2, wherein the cathode 10 is connected to the housing 3, whereas the anode is insulated from housing 3 by the feedthrough capacitor 2.

As can be seen from FIG. 1, the microwave unit 9 is located approximately in the middle of one of the halves of the cavity resonator (here: the left half). In the second, i.e. the right half of the cavity resonator, at another embodiment of the present invention, a polarization unit consisting of two wires 7 is provided, which are aligned substantially parallel to the radiation axis 14 and which are operationally connected to an energy supply provided external to the cavity resonator. The wires are, e.g., made of steel and have a diameter of, e.g., 0.03 mm. For contacting the wires 7, another feedthrough capacitor 8 is provided which allows the transmission of energy into the gastight cavity resonator. For positioning the wires 7 in the cavity resonator, two wire holder elements 6a, 6b are provided, wherein the one wire holder element 6a is arranged in the area of the partially reflecting reflector unit 5 and the other wire holder element 6b in the middle range of the cavity resonator, where also the other feedthrough capacitor 8 is located.

A different form of electrical conductors instead of wires 7 is thinkable for realizing the polarization unit. E.g., also plates of metal mounted on the side and insulated with respect to each other can be used. It is thinkable as well to equip arbitrary sections parallel to the radiation axis 14 with electrical conductors.

In a further embodiment of the present invention, the reflector unit 11 is—as can be seen from FIG. 1—adjustable, which means that the reflector unit 11 is shiftable along the radiation axis 14. Therefor, in an experimental setup according to the present invention shown here, the reflector unit 11 consists of a headless screw with a reflecting layer, wherein the corresponding counter thread to the thread of the headless screw is provided in a backplate 12 belonging to the housing 3, so that an adjustment of the cavity resonator can be carried out from outside. Herewith, at a completely assembled device according to the present invention, a precise adjustment to the already mentioned dimensions can be controlled in a simple way mechanically or upon a suitable modification also electrically.

In another embodiment of the present invention, the housing 3 comprises two closeable openings 1 which are arranged in a distance to each other. Preferably, the one of the openings 1 is—as shown in FIG. 1—arranged in the range of the reflector unit 11, and the other in the range of the partially reflecting reflector unit 5. The openings 1 serve the purpose of injecting a noble gas (e.g. Argon) or a gas mixture into the cavity resonator, wherein the one of the openings 1 is used as inlet and the other as outlet, then. For flooding the inside volume of the housing 3 and the cavity resonator, respectively, the chosen noble gas is injected through the inlet as long as it takes until only the chosen noble gas is detected at the outlet. Thereupon, the openings 1 are closed.

In the embodiment with the reflector unit 11 which is adjustable, e.g., via a screw, the openings 1 are preferably not closed till the adjustment, i.e. the shifting of the reflector unit 11 and of the reflecting layer on the latter, respectively, is finished and the gap of the thread is closed, which can be accomplished with a lacquer/varnish.

FIG. 2 shows a Gunn-diode 9 as it is used in the device according to the invention according to FIG. 1. This Gunn-diode bases on a standard Gunn-diode with the commercial reference MDT/MG1005-11 and comprises a cathode 21, a bonding wire 22 connecting the cathode 21 with a chip 24, the chip 24, also, e.g., referred to as electronic component, which is a GaAs-effect semiconductor chip, and the anode 25.

In FIG. 3A, the chip 24 comprised in the standard Gunn-diode is shown, which has a radiation direction according to FIG. 4A. According to that, the standard Gunn-diode radiates in all directions in the same manner.

In FIG. 3B, the chip is shown, as it is used in a modified Gunn-diode. Only two opposite sides of the six sides of the rectangularly shaped chip 24, namely the sides D and B are transparent for radiation, so that already at this Gunn-diode, an alignment of the generated microwaves takes place. Accordingly, in FIG. 4B the radiation directions are recognizable, which in contrast to the standard Gunn-diode now only show into the directions B and D.

In a further embodiment of the device according to the present invention, the modified Gunn-diode as it has been described by means of FIGS. 3B and 4B is now used in a cavity resonator, and in particular, the modified Gunn-diode is positioned in such a way that the directions of radiation coincide with the radiation axis 14. By this embodiment, a maximum efficiency is reached, which shows up in the device according to the invention through a higher energy emission at constant power consumption.

FIG. 5 shows another embodiment of the microwave unit 9 mentioned in conjunction with FIG. 1. This is a possible schematic setup of a portion of the microwave unit 9 in a section parallel to a direction of propagation 205 of the microwaves. The microwave unit 9 (FIG. 1) comprises the carrier unit 200 made of tough material, e.g., brass or platinum. With this, high forces can be absorbed, if necessary. On the inside of the carrier unit 200, the following layers are comprised in a compact construction, starting from an upper carrier wall: a first insulation layer 201, a microwave component 202, a second insulation layer 203 and a pressure generating element 204 which is, e.g., a piezo-element. Diverse control lines with corresponding contact places for control of the individual layers from a control unit are not shown in FIG. 5.

As a microwave component 202, a Gunn-diode 202 which is a diode based on the Gunn-effect (John Gunn, 1963) is used, which is used in a known manner for the generation of microwaves. For further information on the Gunn-effect and on Gunn-diodes, respectively, it is exemplarily referred to the standard work of Donald Christiansen entitled “Electronics Engineers' Handbook” (McRaw-Hill, fourth edition, 1997, pages 12.71 as well as 12.79 and 12.80). In this publication, also further standard works on this topic are named.

According to the explanations given before, the Gunn-diode 202 is squeezed between the first and the second insulating layer 201 and 203, respectively. By means of the pressure generating element 204, the frequency of the microwaves generated by the Gunn-diode 202 can now be adjusted. It has turned out that with this device, frequencies in the range of 8.7 to 12 GHz can be set. Therein, the frequency shift on the one hand occurs through the pressure onto the Gunn-diode 202 (i.e. the so called “die”) itself, by means of which on the one hand a change in the material inside the Gunn-diode 202 occurs as a consequence of the molecular oscillation change—similarly as in case of a strong change in temperature—, on the other hand through a change of the capacity due to a change of a distance from the Gunn-diode 202 to the carrier unit 200—similarly to a capacity change at the capacitor the plates of which are shifted with respect to each other. Via the pressure generating element 204 therefore the possibility exists to exactly adjust the frequency of the microwaves generated by means of the Gunn-diode. Therewith, the described microwave unit 9 is distinguished from known devices, in particular in that the frequency of the generated microwaves can be set precisely in an electronic way without mechanical adjustment arrangements.

In order for a once adjusted frequency of microwaves to be transmitted to stay constant, the pressure generating element 204 is, in another design of the microwave unit 9, provided with an actually known so called PLL—(Phase-Locked-Loop) or FLL—(Frequency-Locked-Loop) circuit. One of the circuits controls the voltage provided at the pressure generating element 204 in such a way that the desired frequency of the microwaves stays constant.

With 206, it is referred to a window aside the Gunn-diode 202 for the emergence of microwaves. The window 206 is preferably obtained through a suitable doping with foreign atoms. Therewith, a controlled emergence of microwaves out of the Gunn-diode 202 is made possible. For the doping in this case, in particular GaAs (gallium arsenide) is a suitable choice. The diameter of the window 206 amounts to, e.g., about 10 μm and the depth of the doping for example to 32 nm. Finally, the +/− contacts are drawn in FIG. 5, wherein the electrical contacting at the “+”-contact in window 206 and an electrical contacting at the “−”-contact is carried out outside the window 206.

In FIG. 6, an embodiment with a portion of the microwave unit 9 according to FIG. 2 is shown schematically. This portion of the microwave unit can nevertheless also correspond to the portion of the microwave unit 9 shown in FIG. 7 or 8, as well as correspond to a further variant according to FIG. 5. Generally, any known component by means of which microwaves can be generated can be used as a portion of the microwave unit in the before-mentioned sense. With 250, it is referred to the cavity resonator in which also the portions of the microwave unit 9 described by means of FIG. 5 are comprised. FIG. 6 shows an embodiment alternative to FIG. 1 which is described in detail by means of FIG. 7.

The cavity resonator 250 is made of metal and comprises an exit opening 206 through which the microwaves can leave the cavity resonator 250 in propagation direction 205. In cavity resonator 250, on the one hand a ceramics body 234 is comprised which projects from the top into the inside of the cavity resonator 250 and on the other hand a body 235 which projects into the inside of the cavity resonator 250 from below, wherein the upper ceramics body 234 and the body 235 are aligned with respect to each other, i.e. have a common axis, but do not touch each other. Besides the body 235, there is further arranged another ceramics body 236, which is described with reference to the detailed view according to FIG. 7. The body 235 consists of a metal, e.g., of brass or copper, and serves as a cathode or anode, in dependence of the design of the used Gunn-diode. At the same time, excessive heat can be conducted away over the body 235.

From FIG. 7 which is a detailed view A according to FIG. 6, it can be seen that the lower body 235 is carrier element for the following units and layers, respectively (order starting from body 235):
a pressure generating element 204;
a contact layer 203 made of a metal, e.g. of silver or copper;
a Gunn-diode 202.

For the control of the pressure generating element 204, a control line 231 is provided which is connected to a contact place 232 on the other body 236. The contact place 232 is lead out of the cavity resonator 250 via an electric conductor comprised in the other body 236 whereby the possibility for controlling the pressure generating element 204 from outside the cavity resonator 250 is provided. The Gunn-diode 202 arranged above the contact layer 203 is furthermore connected to the ceramics body 234 via a contact loop 230, the ceramic body 234 serving at the same time as feedthrough capacitor and allowing to contact the Gunn-diode 202 from outside cavity resonator 250.

According to the explanation before, the Gunn-diode 202 is attached onto the contact layer 203 and the pressure generating element 204. By means of the pressure generating element 204, the frequency of the microwaves generated by the Gunn-diode 202 can now be adjusted, e.g., between 8.7 and 12 GHz, as it has been found in a test device according to the invention. Therein, the frequency shifting occurs on the one hand through the capacity change due to a distance change between Gunn-diode 202 and the body 235 functioning as a cathode, on the other hand through the change of position with respect to the ceramics body 234 functioning as a feedthrough capacitor. Therefore, by means of the pressure generating element 204, the possibility is provided to exactly set and change the frequency of the microwaves generated by means of the Gunn-diode 202. Also this embodiment distinguishes therefore from known microwave units in that the frequency of the generated microwaves can be adjusted in an electronic way.

Another advantage of this embodiment is the very small design of e.g. 2×1×1 mm for the outer dimensions of the cavity resonator 250, which only has three connectors, namely V_{Gnd}, V_{Gunn} and V_{Piezo}, wherein V_{Gnd} corresponds to the common earth and ground potential, respectively, V_{Gunn} to the supply voltage and the signal tap, respectively, of the gunn diode, and V_{Piezo} to the supply voltage of the pressure generating element and of the tuning of the oscillating circuit connected therewith. The cavity resonator is closed within itself and shows a low sensitivity with respect to outside thermal influences since all HF-carrying components are comprised in the cavity resonator. This circumstance makes it actually ideal for the application in the microsensor technology.

As has already been mentioned in conjunction with the explanations of the embodiment according to FIG. 5, the set frequency of the microwaves to be transmitted can be kept constant by means of so-called PLL (Phase-Locked Loop) or FLL (Frequency-Locked Loop) circuits, which of course is also thinkable in this embodiment. With respect to this, it is referred to the standard work of Donald Christiansen entitled “Electronics Engineer's Handbook” (Fourth Edition, McGraw-Hill, 1996, page 3.40).

FIG. 8 shows a variant which is with respect to the embodiment according to FIG. 7 complemented with an additional inductivity and an additional capacity. Through this, it is prevented that high frequency signal components and microwaves, respectively, can leave the cavity resonator at undesired places. At the same time, an undesired co-vibrating of the piezo element or of other movement bodies is prevented. Other than that, the embodiment according to FIG. 8 is identical with that one according to FIG. 7.

FIG. 9 shows the carrier unit 200 in a side view, wherein again the microwave beam generated in the Gunn diode 202 (FIG. 5) is identified with 205. By embedding the carrier unit 200 with shifting elements 207 to 209, each of which can be formed by a piezo element, the carrier unit 200 as a whole can be shifted and tilted, respectively. In other words, the direction of the microwave beam 205 can be adjusted. In order to be able to cover a range as large as possible with the microwave beam, the shifting element 207 and its counter part (not visible in FIG. 8 because of the covering by the shifting element 207) are mounted in the range of the exit opening of the microwave beam. With these shifting elements 208, the carrier 200 can, according to the arrows labelled 210 and standing perpendicularly on the plane of the drawing, be moved perpendicularly to the plane of drawing.

The two further shifting elements 208 and 209 are arranged at the opposite end of the carrier unit 200, in such a way that the carrier unit 200 can be moved in the plane of drawing of FIG. 9 according to the arrows labelled 211. Therewith, the shifting elements 208 and 209 operate on two of the parallel surfaces of the carrier unit 200, whereas the shifting element 207 and its counter part operate on the other two of the parallel surfaces of the rectangularly shaped carrier unit 200.

For a perfect contacting of the shifting elements 207 to 209, these are on their outsides preferably provided with a silver layer. This enables a simple contacting with control lines 220 to 222 by means of known bonding technique. Belonging thereto, a reference connection 223 is provided for the definition of a reference potential. For this, the reference connection 223 is connected to the carrier unit 200, preferably again by means of the bonding technique.

By means of the described position-adjusting device, the microwave beam can be tilted around two axes, so that a cone of about 2.5° can be covered. If further shifting elements are used, which operate on the third surface pair of the carrier unit 200, in addition, a translatory movement in a third axis can be caused.

It is also thinkable to realize the microwave unit by means of the MEMS (Micro-Electro-Mechanical Systems) technology, by means of which devices according to the invention can be produced, which allow for a very fast and precise change in position. The MEMS technology makes possible the integration of mechanical elements, sensors, actuators and of electronics on the same silicon substrate by means of microfabrication technologies. Whereas electronic components are produced by means of IC (Integrated Circuit) production methods—such as CMOS, bipolar or BICMOS processes—the micro-mechanical components are produced using compatible micro-mechanical methods, in case of which certain portions on a silicon wafer can either be etched away or new structural layers can be added, for forming the mechanical and if necessary the micro-mechanical devices.

FIG. 10 shows an embodiment with a separate receiving diode 237, which receives the reflected microwaves 238 and transfers these into a lower frequency range because of the mixing effect which is by itself known. The receiving diode 237 is therefore arranged offset with respect to the radiation axis 14 (FIG. 1), i.e. it has to be taken care that the receiving diode 237 does not absorb and reflect and change the radiation, respectively, in an undesired way.

As receiving diode 237, in particular a so-called Schottky diode, a so-called Pin diode or a tunnel diode are suitable. Other components, by means of which microwaves can be received, can also be used.

As has been pointed out before, the device according to the invention can be used as a sending as well as a receiving unit. This is possible by an additional receiving diode—as has been shown by means of FIG. 10—as well as without receiving diode.

The device according to the invention can be used, e.g., in the following areas:
Determination of substances in different aggregation states based on characteristic structures.
Detecting molecular movements by application of the Doppler effect.
Medical application, e.g., as scalpel or for the precise removal of damaged heart tissue.
Automatic analyzers for the determination of clinical parameters up to the determination of DNA.
Contactless determination of impurities in liquids, particularly in water.
Real-time surveillance and/or quality assurance of drinking water, food, process sequences at hardly or not at all accessible places. With this, also highly toxic substances can be examined without danger.
For any kind of microbiological application for the determination of viruses, bacteria, etc., the invention is excellently suited, wherein it is insignificant whether the viruses and bacteria, respectively, to be determined are comprised in a solid, liquid or gaseous medium.
Inspecting of weld seams: with the method according to the invention, micro-cracks can be detected with high reliability.
Spectroscopy, environmental analytics and surveillance of the atmosphere and of industrial environments.
Low-range communication in medical technology, in which, e.g., a sender can be positioned inside a living organism and a receiver outside the organism. Between the sender and the receiver data is obtained out of the living organism by means of HF (High Frequency) communication. So, it is thinkable to give an autonomous measuring and transmission unit in form of a pill instead of an enteroscopy (endoskopy) which sends, e.g., by surface probing, predefined data from the inside of the gut, which sends the data to an external receiving station for reporting and/or processing.
Detectors in the near range for the detection of drugs, explosives and other dangerous goods. As range of application, e.g., the customs office, airports, train stations, post, etc. are thinkable, in which a person examination has to be carried out.
Inter-satellite communication.
Communication, in particular wireless data transmission over large distances, via satellite or ATV.

1. Device with a cavity resonator having a housing (3, 4, 12) made of electrically conductive material, the device comprising a reflector unit (11), a microwave unit (9) and a partially reflecting reflector unit (5) provided in the housing (3, 4, 12), the housing (4) including a radiation opening (13), the reflector unit (11), the microwave unit (9), the partially reflecting reflector unit (5) and the radiation opening (13) lying on a radiation axis (14), the microwave unit being arranged between the reflector units (5, 11), a distance between the reflector unit (11) and the partially reflecting reflector unit (5) corresponding to half a wavelength to be generated and to be detected, respectively, or to several times this half wavelength, and wherein a dimension transversal to the radiation axis (14) is at least a quarter of the wavelength.

2. Device according to claim 1, wherein at least section-wise electrical conductors (7) are arranged substantially parallel to the radiation axis (14), and wherein the conductors are operationally connected to an energy supply.

3. Device according to claim 2, wherein the electrical conductors are formed by wires (7).

4. Device according to claim 1, wherein the reflector unit (11) and a reflecting layer provided thereon, respectively, is shiftable along the radiation axis (14).

5. Device according to claim 1, wherein sides of the housing (3) facing inside run substantially parallel to the radiation axis (14) and are reflective.

6. Device according to claim 1, further comprising an energy supply operationally connected to the microwave unit (9) via a feedthrough capacitor.

7. Device according to claim 1, wherein the microwave unit is of Gunn diode type.

8. Device according to claim 7, wherein the Gunn diode has pre-defined principal radiation directions, which substantially coincide with the radiation axis (14).

9. Device according to claim 1, wherein a cavity enclosed by the housing (3) is filled with a gas selected from the group consisting of a noble gas, argon and a gas mixture.

10. Device according to claim 1, wherein the microwave-generating component is mounted between two pressure-generating elements.

11. Device according to claim 5, further comprising at least one servomotor for moving the reflector unit (11) along the radiation axis (14).

12. Device according to claim 5, further comprising piezo motors for moving the reflector unit (11) along the radiation axis (14).

13. Device according to claim 1, further comprising movant elements mounted at the side of the cavity resonator for moving the cavity resonator in at least one axis.

14. Device according to claim 1, further comprising a Schottky type receiving diode (237) in the cavity resonator.

15. Use of a device according to claim 1 in one of the following areas:
Determination of substances in different aggregation states based on characteristic structures;
Detecting molecular movements by application of the Doppler effect;
Medical application;
Automatic analyzers for the determination of clinical parameters;
Contactless determination of impurities of liquids;
Real-time surveillance and/or quality assurance;
Determination of viruses and bacteria;
Inspecting of weld seams;
Spectroscopy;
Low-range communication in medical technology;
Inter-satellite communication;
Communication, in particular wireless data transmission over large distances, via satellite or ATV.
